(19) United States
(12) Patent Application Publication
(10) Pub. No.: US 2011/0310731 A1
(43) Pub. Date: Dec. 22, 2011

(54) CONTROLLING NETWORK RESOURCE USAGE OF MACHINE TYPE COMMUNICATION (MTC) DEVICES

(75) Inventors: Kenneth J. Park, Cathlamet, WA (US); John M. Kowalski, Camas, WA (US)

(73) Assignee: Sharp Laboratories of America, Inc., Camas, WA (US)

(21) Appl. No.: 12/819,176

(22) Filed: Jun. 18, 2010

(51) Int. Cl. H04L 12/26

(52) U.S. Cl. 370/230

(57) ABSTRACT

A method for controlling network resource usage of a machine type communication (MTC) device is described. A request for network resources is received from an MTC application. A notification of a status of the MTC application is sent to a core network (CN). A set of commands is received from the CN. The commands as instructed by the CN are performed.

### TECHNICAL FIELD

The present invention relates generally to wireless communications and wireless communications-related technology. More specifically, the present invention relates to controlling network resource usage of machine type communication (MTC) devices.

### BACKGROUND

Wireless communication devices have become smaller and more powerful in order to meet consumer needs and to improve portability and convenience. Consumers have become dependent upon wireless communication devices and have come to expect reliable service, expanded areas of coverage, and increased functionality. A wireless communication system may provide communication for a number of cells, each of which may be serviced by a base station. A base station may be a fixed station that communicates with mobile stations.

As wireless communication devices have become more advanced, the potential uses of wireless communication devices have also increased. One such advancement is the introduction of machine-to-machine (M2M) devices. These devices may provide little or no human interface. Instead, these devices may provide a wireless link to a base station. The wireless link may be provided to an application that uses the wireless link to send information to and receive information from the base station.

Because these devices do not merely provide an interface for human interaction, many more of these devices may rely on a single base station. With an increase in the number of wireless devices communicating with a base station, there is potential for the base station to be overloaded. Benefits may be realized by preventing the base station from becoming overloaded.

### BRIEF DESCRIPTION OF THE DRAWINGS

FIG. 1 is a block diagram illustrating a wireless communication system;

FIG. 2 is a block diagram illustrating an Open System Interconnection (OSI) model;

FIG. 3 is a block diagram illustrating the transmission of a System Information (SI) message and a paging message from a base station to a machine type communication (MTC) device;

FIG. 4 is a flow diagram of a method for controlling the network resource usage of a machine type communication (MTC) device;

FIG. 5 is another flow diagram of a method for controlling the network resource usage of a machine type communication (MTC) device;

FIG. 6 is a flow diagram of a method for informing the core network (CN) about the status of a machine type communication (MTC) application;

FIG. 7 is a flow diagram of a method for requesting network resources;

FIG. 8 illustrates the transmission of a set of commands from a core network (CN) to a machine type communication (MTC) device;

FIG. 9 illustrates various components that may be utilized in a machine type communication (MTC) device; and

FIG. 10 illustrates various components that may be utilized in a core network.

### DETAILED DESCRIPTION

A method for controlling network resource usage of a machine type communication (MTC) device is described. A request for network resources is received from an MTC application. A notification is sent to a core network (CN) of a status of the MTC application. A set of commands is received from the CN. The commands are performed as instructed by the CN.

A set of device rules governing the network resource usage of the MTC device may be obtained. The set of device rules may be applied each time an MTC application requests network resources. The set of device rules governing the network resource usage of the MTC device may be hard coded on the MTC device at the time of manufacture, sent by the CN to the MTC device or may be a combination of device rules hard coded on the MTC device at the time of manufacture and device rules sent by the CN to the MTC device.

Applying the set of device rules may include comparing a network resource usage metric with a network resource usage threshold. The request for network resources may be denied if the network resource usage metric is greater than the network resource usage threshold. The notification sent to the CN may indicate that the MTC application has exceeded the network resource usage threshold. The request for network resources may be granted if the network resource usage metric is less than the network resource usage threshold. Network resources may then be provided to the MTC application.

The notification sent to the CN may indicate that the MTC application is near to exceeding the network resource usage threshold. The network resource usage metric may be updated. The set of commands may instruct the MTC device to stop providing the MTC application access to network resources, to start providing the MTC application access to network resources, to resume providing the MTC application access to network resources or to report MTC application resource requests over time.

The method may be performed by the MTC device. The method may also be performed by an access stratum (AS) on the MTC device. The set of commands received from the CN may be received via a broadcast control channel (BCH) transport channel or via a downlink shared channel (DL-SCH) transport channel. The device rules may take into account at least one of: a number of access requests made by the MTC application over a given period of time, a number of access attempts made by the MTC device over a given period of time, an amount of time and frequency resources used over a given period of time, and a current traffic load on a network.

An apparatus configured for controlling network resource usage of a machine type communication (MTC) device is also described. The apparatus includes a processor, memory in electronic communication with the processor and instructions stored in the memory. The instructions are executable by the processor to receive a request for network resources from an MTC application. The instructions are also executable by the processor to send a notification to a core network (CN) of a status of the MTC application. The instructions are further executable by the processor to receive a set of commands from the CN. The instructions are also executable by the processor to perform the commands as instructed by the CN.

A method for controlling network resource usage of a machine type communication (MTC) device by a core network (CN) is described. A notification is received from the MTC device. A set of commands is generated in response to the notification. The set of commands is sent to the MTC device.

The notification may indicate that an MTC application has exceeded a network resource usage threshold or that an MTC application is near to exceeding a network resource usage threshold. The set of commands may instruct the MTC device to stop providing an MTC application access to network resources, to start providing an MTC application access to network resources, to resume providing the MTC application access to network resources or to report MTC application resource requests over time.

An apparatus configured for controlling network resource usage of a machine type communication (MTC) device is also described. The apparatus includes a processor, memory in electronic communication with the processor and instructions stored in the memory. The instructions are executable to receive a notification from the MTC device. The instructions are also executable to generate a set of commands in response to the notification. The instructions are further executable to send the set of commands to the MTC device.

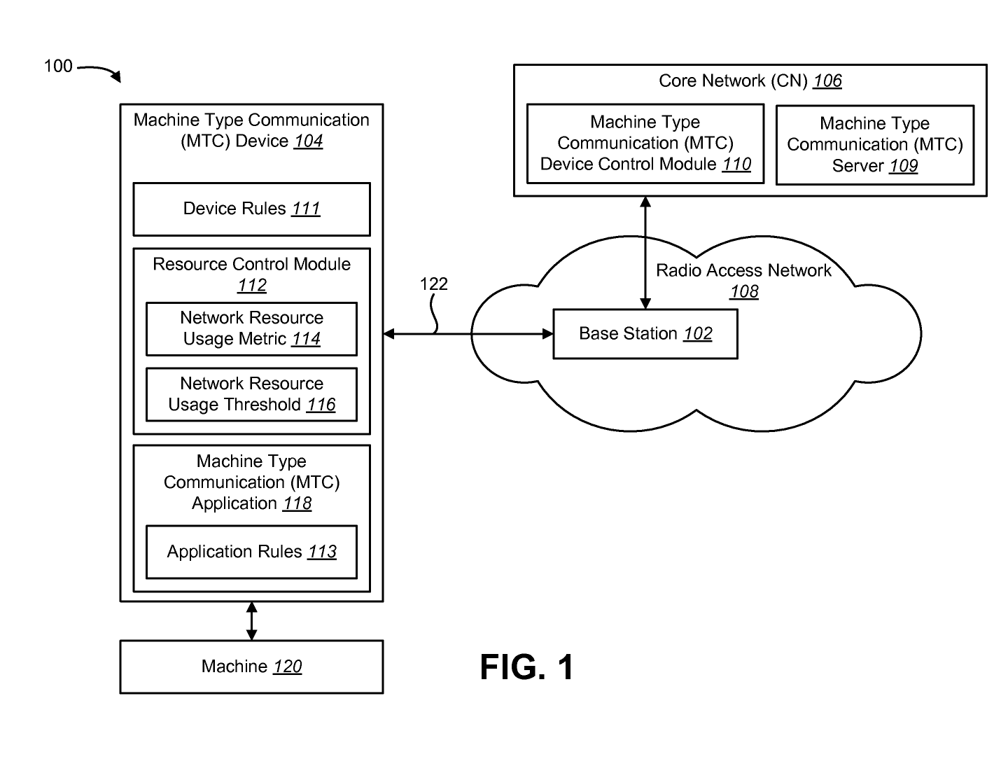

FIG. 1 is a block diagram illustrating a wireless communication system 100. The wireless communication system 100 may include a core network (CN) 106, a base station 102, a machine type communication (MTC) device 104 and a machine 120. A base station 102 may be in wireless communication with one or more machine type communication (MTC) devices 104. A base station 102 may be referred to as an access point, a Node B, an eNodeB, or some other terminology. The term “base station” is used herein. The base station 102 and its coverage area may be referred to as a radio access network (RAN) 108. A wireless communication device (not shown) may be referred to as a mobile station, a subscriber station, an access terminal, a remote station, a user terminal, a terminal, a handset, a subscriber unit, user equipment (UE), or some other terminology. The term “wireless communication device” is used herein.

A wireless communication device may be a cellular phone, a smart phone, a laptop, a personal digital assistant (PDA), a wireless modem, etc. A wireless communication device may transmit data to the base station 102 over a radio frequency (RF) communication channel. Likewise, the base station 102 may transmit data to the wireless communication device over a radio frequency (RF) communication channel.

A machine type communication (MTC) device 104 may communicate with zero, one or multiple base stations 102 over a radio frequency (RF) communication channel 122. In one configuration, the machine type communication (MTC) device 104 may communicate with the base station 102 on the downlink and/or uplink at any given moment. The downlink refers to the communication link from a base station 102 to a wireless device such as a wireless communication device or a machine type communication (MTC) device 104. The uplink refers to the communication link from a wireless device such as a wireless communication device or a machine type communication (MTC) device 104 to a base station 102. The communication link may be established using a single-input and single-output (SISO), multiple-input and single-output (MISO) or a multiple-input and multiple-output (MIMO) system. A MIMO system may include both a transmitter and a receiver equipped with multiple transmit and receive antennas.

The Third Generation Partnership Project (3GPP) is a collaboration between groups of telecommunications associations to make globally applicable mobile phone system specifications. Long Term Evolution (LTE) is the project name of a high performance air interface for cellular mobile telephony. Long Term Evolution Advanced (LTE-A) is a mobile communication standard that works as an enhancement to the LTE air interface. In 3GPP LTE-A Release 10, specifications include functionality that enables the use of machine type communication (MTC) devices 104.

A machine type communication (MTC) device 104 is similar to a wireless communication device, except the primary function does not provide a user interface. A machine type communication (MTC) device 104 may use the physical (PHY) layer, medium access control (MAC) layer, radio link control (RLC) layer, the Packet Data Convergence Protocol (PDCP) and the Radio Resource Control (RRC) layer to establish a communication link 122 with a base station 102 and the core network (CN) 106. However, a machine type communication (MTC) device 104 may not provide a human interface. Instead, a machine type communication (MTC) device 104 may operate as a network access point between machines 120 (i.e., between data acquisition/data aggregation devices and a machine type communication (MTC) server 109). A machine type communication (MTC) server 109 may be a device that uses the core network (CN) 106 to facilitate a connection with a machine type communication (MTC) application 118. Examples of machine type communication (MTC) devices 104 include surveillance equipment, utility measurement devices, fleet management devices and production chain monitoring devices.

A base station 102 may be configured to establish communication links with multiple wireless communication devices and/or multiple machine type communication (MTC) devices 104. Because of the limited communication requirements for machine type communication (MTC) devices 104, many more machine type communication (MTC) devices 104 may be influenced by a base station 102 than wireless communication devices influenced by the base station 102. It is predicted that ten times as many machine type communication (MTC) devices 104 as wireless communication devices may be under the influence of a base station 102.

While most machine type communication (MTC) devices 104 are expected to behave in a predictable and suitable manner, it is reckless to allow an autonomous device (i.e., a machine type communication (MTC) device 104) access to network resources without some method of admittance control. There are many mechanisms in which a machine type communication (MTC) device 104 may fail during normal operations. Such a failure may result in congestion of the radio access network (RAN) 108 access channels. For example, a machine type communication (MTC) device 104 that has failed may perform an excessive number of radio access network (RAN) 108 access attempts or consume excessive network resources over a period of time. Network resources may refer to Internet Protocol (IP) services, IP Multimedia Subsystem (IMS) services, Evolved Packet System (EPS) bearer services, Emergency bearer services, Short Message Service (SMS) services, etc.

Machine type communication (MTC) devices 104 are autonomous and their operation is governed by a set of device rules 111. The device rules 111 may describe how a resource control module 112 on the machine type communication (MTC) device 104 uses network resources. In one configuration, the device rules 111 may monitor how often and to what extent a machine type communication (MTC) application 118 is requesting and using the radio access network (RAN) 108 resources. The source of the device rules 111 may be the core network (CN) 106 or default settings.

A machine type communication (MTC) application 118 may not be under the 3GPP specification. In other words, a machine type communication (MTC) application 118 may not be governed by the rules of the 3GPP specification. Instead, a machine type communication (MTC) application 118 may have a set of application rules 113 that describes how the machine type communication (MTC) application 118 is to work. The application rules 113 may indicate how often and under what conditions or even triggers the machine type communication (MTC) application 118 is to report its status and measurements back to a machine type communication (MTC) server 109.

As an example, the power utility may install a “smart meter” on a house. The “smart meter” may be a type of machine type communication (MTC) application 118. The power utility may use a machine type communication (MTC) sever 109 to access (i.e., control, get data from, send data to) the machine type communication (MTC) application 118. The machine type communication (MTC) server 109 may use the services of the core network (CN) 106 to establish a communication channel with the machine type communication (MTC) device 104 and ultimately with the machine type communication (MTC) application 118. The machine type communication (MTC) server 109 may be represented as part of the core network (CN) 106 as shown in FIG. 1. Alternatively, the machine type communication (MTC) server 109 may be external to the core network (CN) 106.

If the application rules 113 should become corrupted as a result of a hardware or software failure, the machine type communication (MTC) application 118 may operate in a manner that is detrimental to the radio access network (RAN) 108.

Machine type communication (MTC) devices 104 may be provisioned at the application level (i.e., at a functional level that is not covered by the 3GPP specification) by a machine type communication (MTC) server 109. The provisioning data is used to configure the application rules 113 that define how the machine type communication (MTC) application 118 is to operate. The application rules 113 may take into account how often to report, what kind of data to report, specific events that will trigger a report, etc.

Machine type communication (MTC) devices 104 may be provisioned at the device level by the core network (CN) 106. The provisioning data may be used to configure the device rules 111 that define how the machine type communication (MTC) device 104 is to operate. The device rules 111 may take into account a network resource usage metric 114 that reflects networks resource information such as the number of access requests made by a machine type communication (MTC) application 118 over a given period of time, the number of access requests made by a machine type communication (MTC) device 104 over a given period of time, the amount of time and frequency resources used over a given period of time and the current traffic load on the network.

The device rules 111 may be a default set that are hard coded on the machine type communication (MTC) device 104 at the time of manufacture. The device rules 111 may also be a configured set of device rules 111 that are sent by the core network (CN) 106 to the machine type communication (MTC) device 104 via wireless resources. The wireless resources used to send the device rules 111 to the machine type communication (MTC) device 104 may be broadcast resources (i.e., using the broadcast control channel (BCH) transport channel) or dedicated resources (i.e., using the downlink shared channel (DL-SCH) transport channel). In one configuration, the device rules 111 may be a combination of the default set and the configured set sent by the core network (CN) 106. The device rules 111 may be executed each time a machine type communication (MTC) application 118 requests the machine type communication (MTC) device 104 to provide network resources.

In one configuration, the provisioning data (i.e., the application rules 113) may indicate how often and under what conditions the machine type communication (MTC) application 118 is to report its status and measurements back to the machine type communication (MTC) server 109. If the provisioning data generated by the machine type communication (MTC) server 109 and sent to the machine type communication (MTC) application 118 is corrupted (either accidentally or maliciously), the machine type communication (MTC) application 118 may operate in a manner that is detrimental to the radio access network (RAN) 108. As an example, the machine type communication (MTC) server 109 may want the machine type communication (MTC) application 118 to report every 100 seconds. However, the application rules 113 may become corrupted so that the machine type communication (MTC) application 118 sends a report every 100 milliseconds, causing a lot of problems for the device layer.

The current LTE-A specification for operation of wireless communication devices does not provide a mechanism implemented in the machine type communication (MTC) device 104 that limits the number of access attempts that the machine type communication (MTC) device 104 can make over a given period of time. The machine type communication (MTC) device 104 may include a resource control module 112 to remedy this problem. The resource control module 112 may provide conditions that limit the network resource usage of a machine type communication (MTC) application 118 on the machine type communication (MTC) device 104. The resource control module 112 may thus provide an LTE-A compliant machine type communication (MTC) device 104 the ability to detect that a machine type communication (MTC) application 118 is operating outside of baseline parameters, and to further prevent the machine type communication (MTC) application 118 from causing harm to the network. Examples of machine type communication (MTC) applications 118 include remote meter readers, highway traffic sensors and vending machine status reporters.

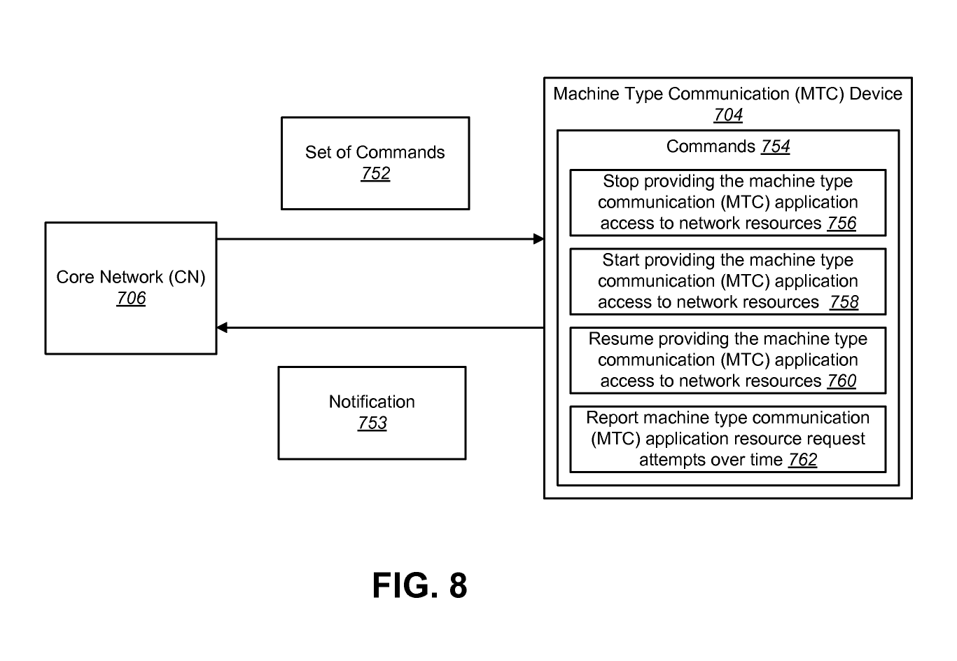

The resource control module 112 may also allow the machine type communication (MTC) device 104 to receive and implement commands sent by a machine type communication (MTC) device control module 110 on the core network (CN) 106. Commands sent from the core network (CN) 106 are discussed in further detail below in relation to FIG. 8.

The resource control module 112 may include the network resource usage metric 114. The resource control module 112 may also include a network resource usage threshold 116. The network resource usage threshold 116 may be a predefined or programmable threshold used by the resource control module 112 to determine whether to provide network resources to a machine type communication (MTC) application 118.

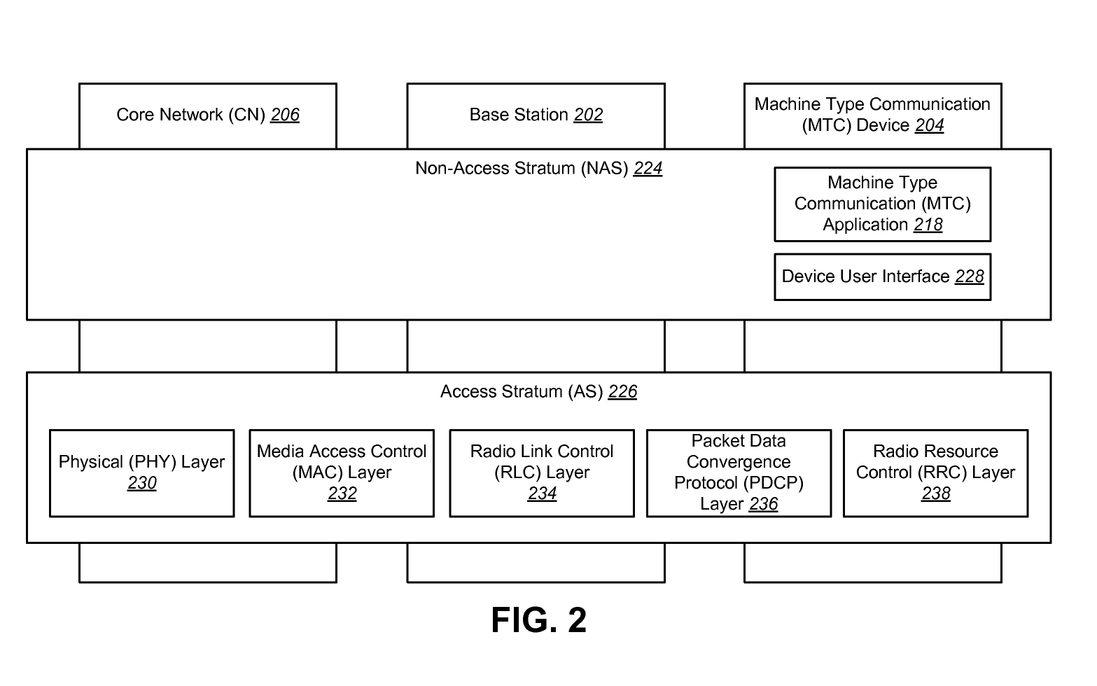

FIG. 2 is a block diagram illustrating an Open System Interconnection (OSI) model. This model is a way of subdividing a system in smaller parts (called layers) from the point of view of communications. A layer is a collection of conceptually similar functions that provides services to the layer above it and receives services from the layer below it. Each layer may provide services to the layer above and request services from the layer below. The Open System Interconnection (OSI) model may facilitate communications between a core network (CN) 206, a base station 202 and a machine type communication (MTC) device 204. The base station 202 of FIG. 2 may be one configuration of the base station 102 of FIG. 1. The machine type communication (MTC) device 204 of FIG. 2 may be one configuration of the machine type communication (MTC) device 104 of FIG. 1. The core network (CN) 206 of FIG. 2 may be one configuration of the core network (CN) 106 of FIG. 1.

In the Open System Interconnection (OSI) model, the layers may be divided into two groups: an access stratum (AS) 226 and a non-access stratum (NAS) 224. Access stratum (AS) 226 and non-access stratum (NAS) 224 are 3GPP terms. The access stratum (AS) 226 includes the layers of the Open System Interconnection (OSI) model used to setup, maintain and terminate an LTE data connection between a machine type communication (MTC) device 204 and a base station 202. In the 3GPP LTE and LTE-A specifications, the physical (PHY) layer 230, media access control (MAC) layer 232, radio link control (RLC) layer 234, packet data convergence protocol (PDCP) layer 236 and the radio resource control (RRC) layer 238 are all part of the access stratum (AS) 226. An LTE system may use the radio resource control (RRC) layer 238 to handle the transport of dedicated information between a machine type communication (MTC) device 204 or a wireless communication device and a base station 202 control plane.

The non-access stratum (NAS) 224 includes those layers used to service machine type communication (MTC) applications 218 and the device user interface 228 on the machine type communication (MTC) device 204. In the LTE system, the Evolved Packet System (EPS) Mobility Management (EMM) protocol provides procedures for the control of mobility when wireless devices (such as a wireless communication device or a machine type communication (MTC) device 204) are using the Evolved UMTS (Universal Mobile Telecommunications System) Terrestrial Radio Access Network (E-UTRAN). The EMM protocol also provides control of security for the non-access stratum (NAS). The procedures are used by the protocols for mobility management and session management between a wireless device and a Mobility Management Entity (MME) in the Evolved Packet System (EPS). These protocols belong to the non-access stratum (NAS) 224. An application layer is a layer that is supported by the non-access stratum (NAS) 224. The access stratum (AS) 226 provides radio access network (RAN) 108 resource to the non-access stratum (NAS) 224. Applications 218 that are running on the machine type communication (MTC) device 204 are considered part of the non-access stratum (NAS) 224.

As discussed above, 3GPP LTE-A Release 10 specifications include functionality that enables the use of machine type communication (MTC) devices 204. A machine type communication (MTC) device 204 is similar to a wireless communication device in that it uses the access stratum (AS) 226 layers to establish a communication link with the base station 202. But a machine type communication (MTC) device 204 differs from a wireless communication device because the machine type communication (MTC) device 204 does not provide the standard human interface of a typical handset. Instead, the purpose of a machine type communication (MTC) device 204 is to operate as a radio access network (RAN) 108 access point between machines 120 (i.e., between data acquisition/data aggregation devices and the machine type communication (MTC) server 109). The machine type communication (MTC) device 204 may still use the non-access stratum (NAS) 224 to support the applications 218 that run on the machine type communication (MTC) device 204 and require network resources.

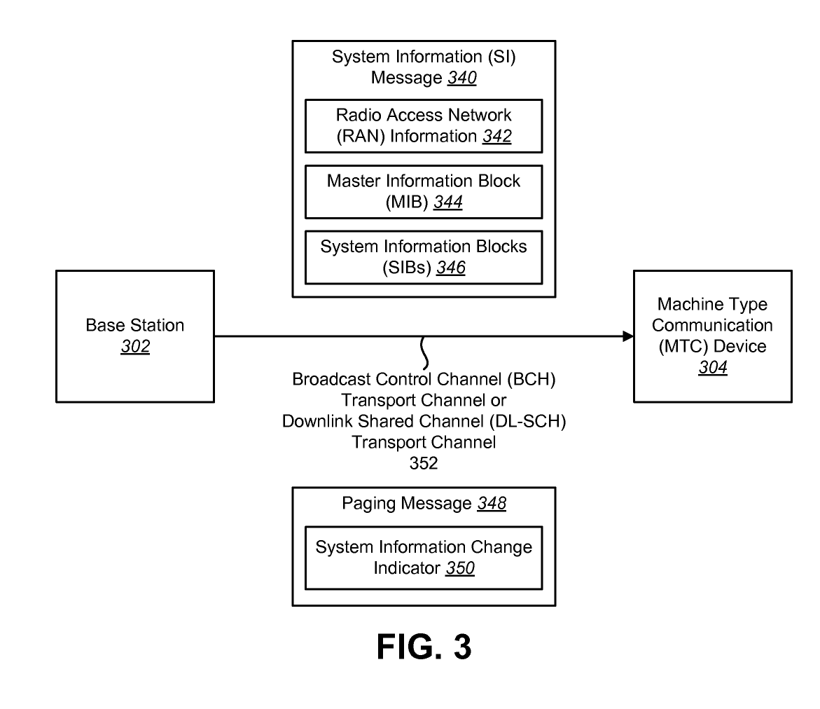

FIG. 3 is a block diagram illustrating the transmission of a System Information (SI) message 340 and a paging message 348 from a base station 302 to a machine type communication (MTC) device 304. The base station 302 of FIG. 3 may be one configuration of the base station 102 of FIG. 1. The machine type communication (MTC) device 304 of FIG. 3 may be one configuration of the machine type communication (MTC) device 104 of FIG. 1. The base station 302 may broadcast a downlink radio frame that includes the system information message 340. The wireless resources 352 used to send messages from the base station 302 to the machine type communication (MTC) device 304 may be broadcast resources (i.e., using the broadcast control channel (BCH) transport channel) or dedicated resources (i.e., using the downlink shared channel (DL-SCH) transport channel).

In LTE-A, the base station 302 broadcasts information necessary for a wireless communication device or a machine type communication (MTC) device 304 to establish a communication link with the network via System Information (SI) messages 340. System information is divided into the master information block (MIB) 344 and a number of system information blocks (e.g., SIB1 . . . SIB12) 346. A first system information block 346 may be referred to as SystemInformationBlockType1 (SIB1) and may include scheduling information in SchedulingInfoList that indicates where emergency information such as ETWS/CMAS SIB messages are located and a system information change indicator systemInfoValueTag that indicates a change in the System Information (SI) message 340 has occurred. A second system information block 346 may be referred to as SystemInformationBlockType2 (SIB2) and may include a hierarchical partitioning of wireless communication devices and machine type communication (MTC) devices 304 in ac-BarringInfo. The system information (SI) message 340 may also include radio access network (RAN) information 342.

A base station 302 may broadcast a paging message 348 to inform a wireless device such as a wireless communication device or a machine type communication (MTC) device 304 of a system information change. A paging message 348 may be broadcast periodically at the wireless communication device's or machine type communication (MTC) device's 304 paging occasion. The paging occasion may be determined by the International Mobile Equipment Identity (IMEI) of a wireless communication device or machine type communication (MTC) device 304 and system configuration settings.

The paging message 348 may include a system information change indicator 350. The system information change indicator 350 may be the data field systemInfoModification, which when set indicates that System Information (SI) data is scheduled to change at the next Modification Period boundary. A Modification Period boundary limits when changes to the updated access class in SIB2 data are allowed. Change of SIB2 data only occurs at specific radio frames. SIB2 data may be transmitted a number of times with the same content within a modification period, as defined by its scheduling. When systemInfoModification is set during “modification period N” then the change will not occur until “modification period N+1.”

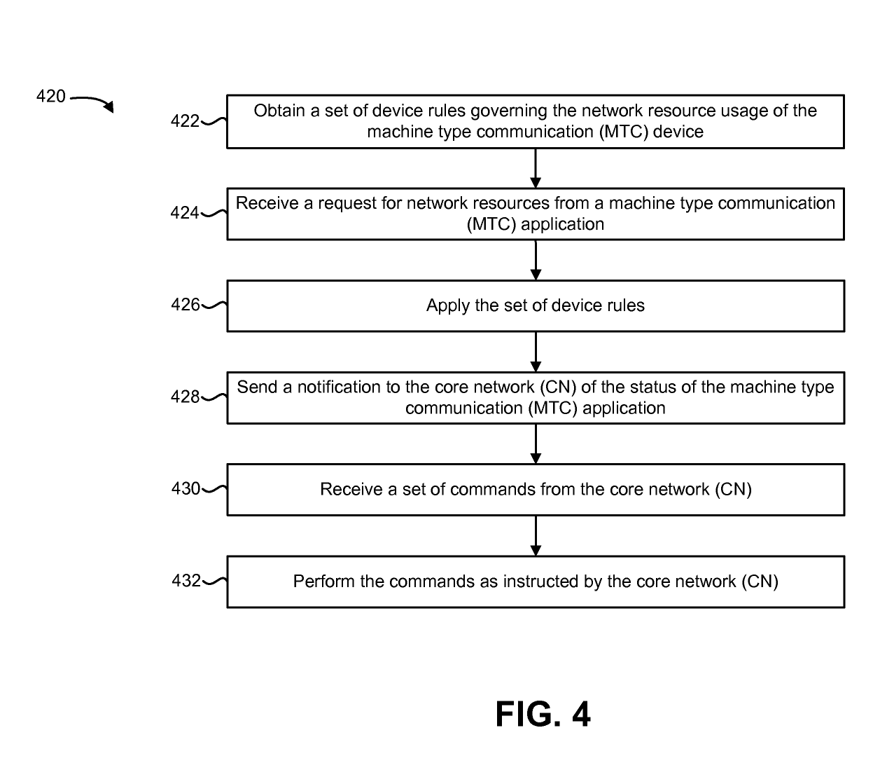

FIG. 4 is a flow diagram of a method 420 for controlling the network resource usage of a machine type communication (MTC) device 104. The method 420 may be performed by a machine type communication (MTC) device 104. The machine type communication (MTC) device 104 may obtain 422 a set of device rules 111 governing the network resource usage of the machine type communication (MTC) device 104. The machine type communication (MTC) device 104 may then receive 424 a request for network resources from a machine type communication (MTC) application 118. The machine type communication (MTC) application 118 may be running on the machine type communication (MTC) device 104.

The machine type communication (MTC) device 104 may apply 426 the set of device rules 111. Applying 426 the set of device rules 111 may determine whether the machine type communication (MTC) device 104 provides the machine type communication (MTC) application 118 access to network resources. The machine type communication (MTC) device 104 may then send 428 a notification to the core network (CN) 106 of the status of the machine type communication (MTC) application 118. In one configuration, the notification may indicate whether the machine type communication (MTC) application 118 was granted network resources. The notification may be sent to the machine type communication (MTC) device control module 110 on the core network (CN) 106.

The machine type communication (MTC) device 104 may receive 430 a set of commands from the machine type communication (MTC) device control module 110 of the core network (CN) 106. The commands may instruct the machine type communication (MTC) device 104 regarding the machine type communication (MTC) application's 118 requests for network resources. For example, the commands may instruct the machine type communication (MTC) device 104 to stop providing the machine type communication (MTC) application 118 access to network resources, to start providing the machine type communication (MTC) application 118 access to network resources, to resume providing the machine type communication (MTC) application 118 access to network resources or to report machine type communication (MTC) application 118 resource request attempts over time. The machine type communication (MTC) device 104 may then perform 432 the commands as instructed by the machine type communication (MTC) device control module 110 of the core network (CN) 106.

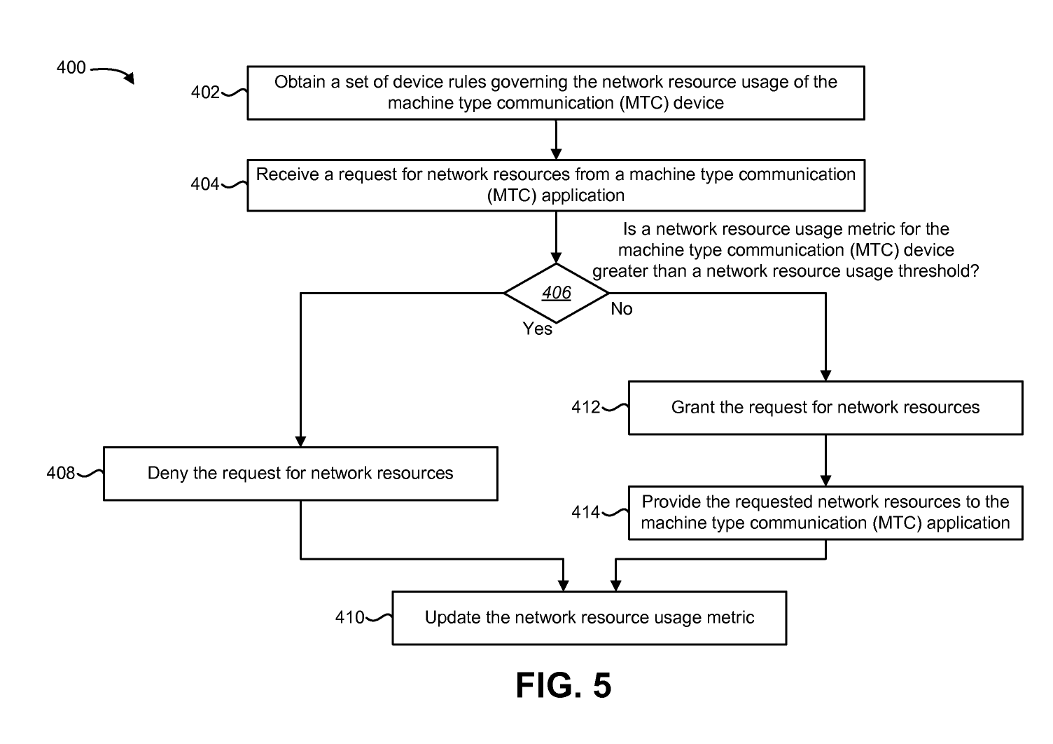

FIG. 5 is another flow diagram of a method 400 for controlling the network resource usage of a machine type communication (MTC) device 104. The method 400 may be performed by the machine type communication (MTC) device 104. In one configuration, the method 400 may be performed by the access stratum (AS) 226 of the machine type communication (MTC) device 104.

The machine type communication (MTC) device 104 may obtain 402 a set of device rules 111 governing the network resource usage of the machine type communication (MTC) device 104. In one configuration, the set of device rules 111 may be a default set of rules (i.e., rules defined at the time of manufacture of the machine type communication (MTC) device 104). In another configuration, the set of device rules 111 may be configured by the core network (CN) 106. The set of device rules 111 is used to monitor how often and to what extent a machine type communication (MTC) application 118 on the machine type communication (MTC) device 104 is requesting and using network resources. The set of device rules 111 may include a network resource usage threshold 116.

The machine type communication (MTC) device 104 may receive 404 a request for network resources from the machine type communication (MTC) application 118. The request for network resources may be a request for the access stratum (AS) 226 to attempt to acquire radio access network (RAN) 108 resources for use by the machine type communication (MTC) application 118.

The machine type communication (MTC) device 104 may determine 406 whether a network resource usage metric 114 for the machine type communication (MTC) device 104 is greater than a network resource usage threshold 116. The machine type communication (MTC) device 104 may thus compare a current network resource usage metric 114 (e.g., the total number of radio access network (RAN) 108 resources requested, the number of radio access network (RAN) 108 resources requested over a time period, or the current number or radio access network (RAN) 108 resources used by the machine type communication (MTC) device 104) to a network resource usage threshold 116. The network resource usage threshold 116 may be programmable (i.e., updated by the machine type communication (MTC) device control module 110 of the core network (CN) 106).

If the network resource usage metric 114 is greater than the network resource usage threshold 116, the machine type communication (MTC) device 104 may deny 408 the request for network resources. The machine type communication (MTC) device 104 may then update 410 the network resource usage metric 114. For example, the machine type communication (MTC) device 104 may adjust the network resource usage metric 114 to account for the denied request for network resources.

If the network resource usage metric 114 is not greater than the network resource usage threshold 116, the machine type communication (MTC) device 104 may grant 412 the request for network resources. The machine type communication (MTC) device 104 may provide 414 the requested network resources to the machine type communication (MTC) application 118. The machine type communication (MTC) device 104 may then update 410 the network resource usage metric 114. For example, the machine type communication (MTC) device 104 may reduce or reset the network resource usage metric 114.

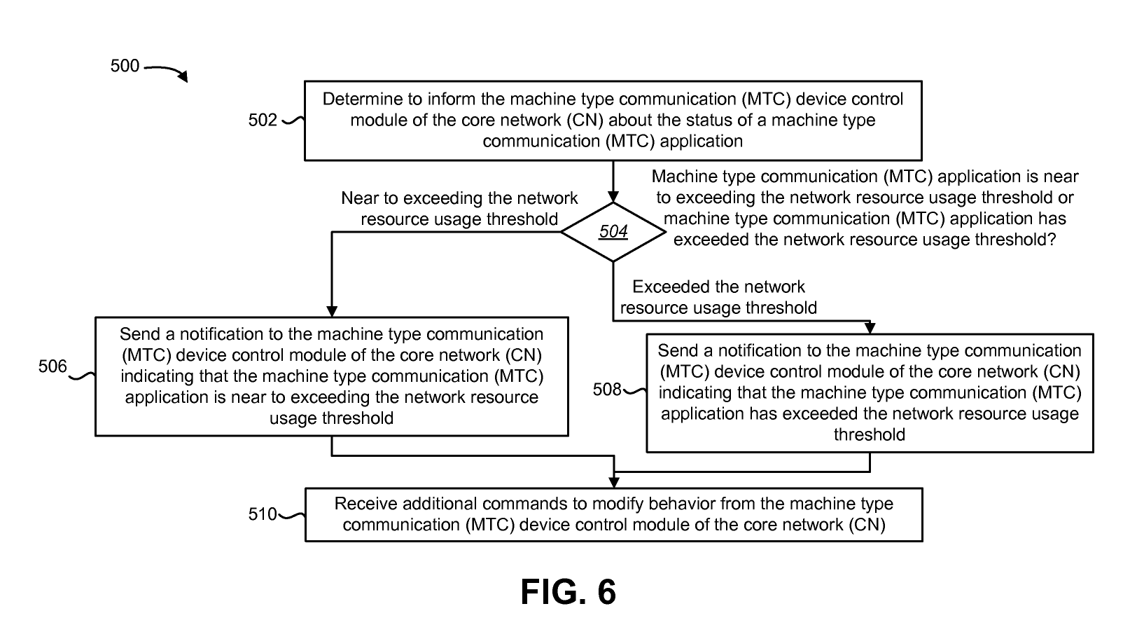

FIG. 6 is a flow diagram of a method 500 for informing the machine type communication (MTC) device control module 110 of the core network (CN) 106 about the status of a machine type communication (MTC) application 118. The method 500 may be performed by a machine type communication (MTC) device 104. The machine type communication (MTC) application 118 may be running on the machine type communication (MTC) device 104.

The machine type communication (MTC) device 104 may determine 502 to inform the machine type communication (MTC) device control module 110 of the core network (CN) 106 about the status of the machine type communication (MTC) application 118. In one configuration, the machine type communication (MTC) device 104 may determine 502 to inform the machine type communication (MTC) device control module 110 of the core network (CN) 106 about the status of the machine type communication (MTC) application 118 as a result of the execution of a set of device rules 111 for the machine type communication (MTC) device 104. The machine type communication (MTC) device 104 may determine 502 to inform the machine type communication (MTC) device control module 110 of the core network (CN) 106 about the status of a machine type communication (MTC) application 118 because the machine type communication (MTC) application 118 (or the machine type communication (MTC) device 104) is near to exceeding or has exceeded the network resource usage threshold 116.

The machine type communication (MTC) device 104 may determine 504 whether the machine type communication (MTC) application 118 is near to exceeding the network resource usage threshold 116 (i.e., the network resource usage metric 114 is within a threshold of the network resource usage threshold 116) or whether the machine type communication (MTC) application 118 has exceeded the network resource usage threshold 116 (i.e., the network resource usage metric 114 is greater than the network resource usage threshold 116). If the machine type communication (MTC) application 118 is near to exceeding the network resource usage threshold 116, the machine type communication (MTC) device 104 may send 506 a notification to the machine type communication (MTC) device control module 110 of the core network (CN) 106 indicating that the machine type communication (MTC) application 118 is near to exceeding the network resource usage threshold 116. The machine type communication (MTC) device 104 may then receive 510 additional commands to modify behavior from the machine type communication (MTC) device control module 110 of the core network (CN) 106. Receiving additional commands from the machine type communication (MTC) device control module 110 of the core network (CN) 106 is discussed in further detail below in relation to FIG. 8.

If the machine type communication (MTC) application 118 has exceeded the network resource usage threshold 116, the machine type communication (MTC) device 104 may send 508 a notification to the machine type communication (MTC) device control module 110 of the core network (CN) 106 indicating that the machine type communication (MTC) application 118 has exceeded the network resource usage threshold 116. The machine type communication (MTC) device 104 may then receive 510 additional commands to modify behavior from the machine type communication (MTC) device control module 110 of the core network (CN) 106. Receiving additional commands from the machine type communication (MTC) device control module 110 of the core network (CN) 106 is discussed in further detail below in relation to FIG. 8.

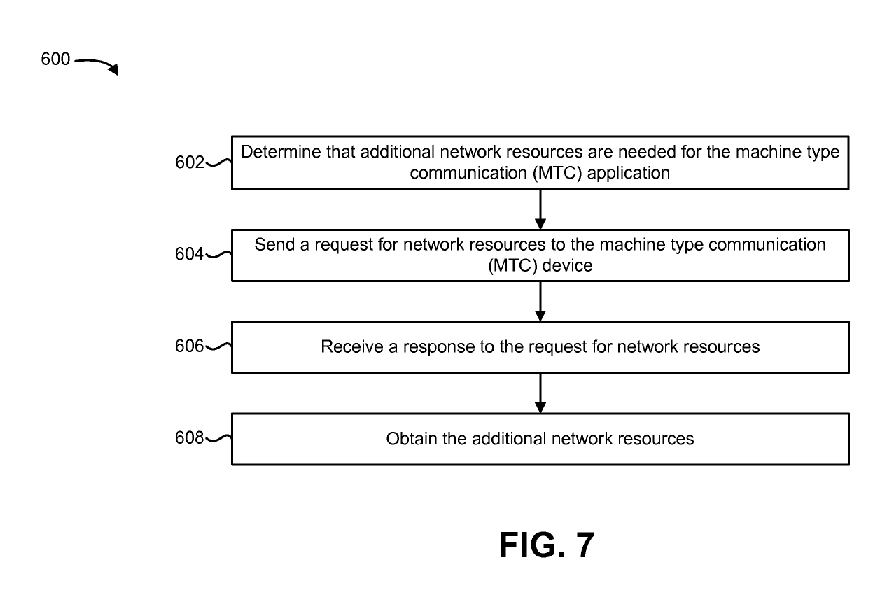

FIG. 7 is a flow diagram of a method 600 for requesting network resources. The method 600 may be performed by a machine type communication (MTC) application 118 on a machine type communication (MTC) device 104. The machine type communication (MTC) application 118 may determine 602 that additional network resources are needed for the machine type communication (MTC) application 118 (i.e., that the machine type communication (MTC) application 118 needs to establish a connection to the machine type communication (MTC) server 109).

The machine type communication (MTC) application 118 may send 604 a request for network resources to the machine type communication (MTC) device 104. In one configuration, the machine type communication (MTC) application 118 may send a request for network resources to the non-access stratum (NAS) 224 of the machine type communication (MTC) device 104. The machine type communication (MTC) application 118 may then receive 606 a response to the request for network resources.

In one configuration, the response may grant network resources to the machine type communication (MTC) application 118. In another configuration, the response may deny network resources to the machine type communication (MTC) application 118. If the response grants network resources, the machine type communication (MTC) application 118 may obtain 608 the additional network resources.

FIG. 8 illustrates the transmission of a set of commands 752 from a core network (CN) 706 to a machine type communication (MTC) device 704. The core network (CN) 706 of FIG. 8 may be one configuration of the core network (CN) 106 of FIG. 1. The machine type communication (MTC) device 704 of FIG. 8 may be one configuration of the machine type communication (MTC) device 104 of FIG. 1.

The core network (CN) 706 may receive a notification 753 of the status of a machine type communication (MTC) application 118 from the machine type communication (MTC) device 704. The core network (CN) 706 may generate and send a set of commands 752 for the machine type communication (MTC) device 704 to control the actions of the machine type communication (MTC) device 704.

The machine type communication (MTC) device 704 may be provided with a set of commands 752 from the core network (CN) 706 via wireless resources. In one configuration, the wireless resources used to send the set of commands 752 to the machine type communication (MTC) device 704 may be broadcast resources (i.e., using the broadcast control channel (BCH) transport channel). In another configuration, the wireless resources used to send the set of commands 752 to the machine type communication (MTC) device 704 may be dedicated resources (i.e., using the downlink shared channel (DL-SCH) transport channel). The core network (CN) 706 may send the set of commands 752 to the machine type communication (MTC) device 704 in response to the machine type communication (MTC) device 704 reporting network resource usage conditions to the core network (CN) 706.

The machine type communication (MTC) device 704 may respond to the set of commands 752 from the core network (CN) 706 regarding the machine type communication (MTC) application's 118 requests for network resources by performing the commands 754. The commands 754 may include a command to stop 756 providing the machine type communication (MTC) application 118 access to network resources. The commands 754 may also include a command to start 758 providing the machine type communication (MTC) application 118 access to network resources. The commands 754 may further include a command to resume 760 providing the machine type communication (MTC) application 118 access to network resources. The commands 754 may also include a command to report 762 machine type communication (MTC) application 118 resource request attempts over time to the core network (CN) 706.

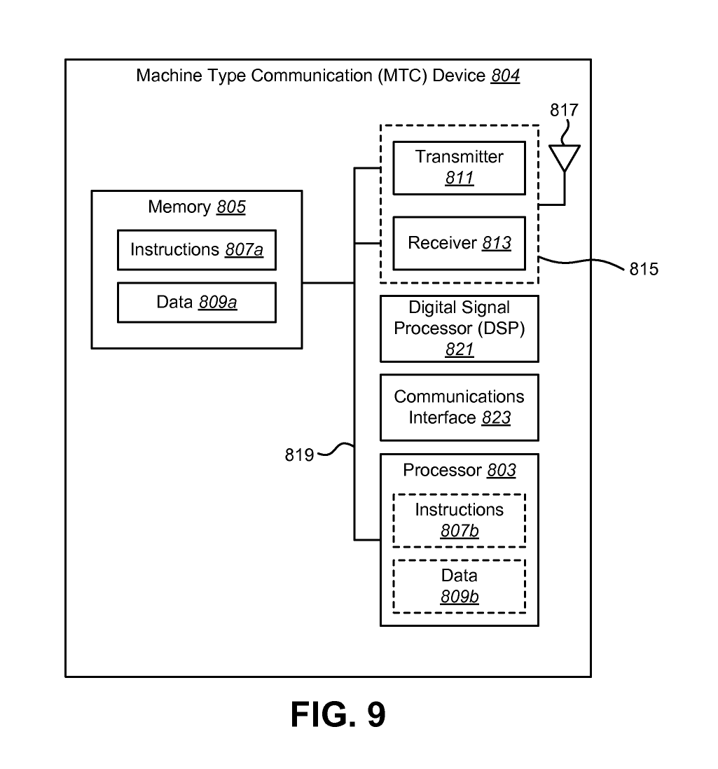

FIG. 9 illustrates various components that may be utilized in a machine type communication (MTC) device 804. The machine type communication (MTC) device 804 may be a remote meter reader, a disease management device, a navigation system, a surveillance system, etc. The machine type communication (MTC) device 804 includes a processor 803 that controls operation of the machine type communication (MTC) device 804. The processor 803 may also be referred to as a CPU. Memory 805, which may include both read-only memory (ROM), random access memory (RAM) or any type of device that may store information, provides instructions 807a and data 809a to the processor 803. A portion of the memory 805 may also include non-volatile random access memory (NVRAM). Instructions 807b and data 809b may also reside in the processor 803. Instructions 807b loaded into the processor 803 may also include instructions 807a from memory 805 that were loaded for execution by the processor 803. The instructions 807b may be executed by the processor 803 to implement the methods disclosed herein.

The machine type communication (MTC) device 804 may also include a housing that includes a transmitter 811 and a receiver 813 to allow transmission and reception of data. The transmitter 811 and receiver 813 may be combined into a transceiver 815. An antenna 817 is attached to the housing and electrically coupled to the transceiver 815. Additional antennas may also be used.

The various components of the machine type communication (MTC) device 804 are coupled together by a bus system 819 which may include a power bus, a control signal bus, and a status signal bus, in addition to a data bus. However, for the sake of clarity, the various buses are illustrated in FIG. 9 as the bus system 819. The machine type communication (MTC) device 804 may also include a digital signal processor (DSP) 821 for use in processing signals. The machine type communication (MTC) device 804 may further include a communications interface 823 that provides user access to the functions of the machine type communication (MTC) device 804. The machine type communication (MTC) device 804 illustrated in FIG. 9 is a functional block diagram rather than a listing of specific components.

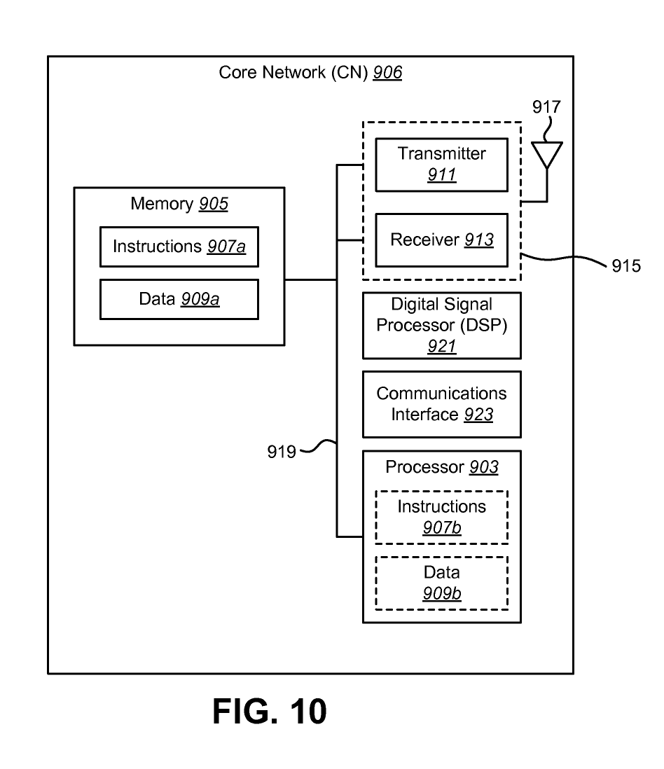

FIG. 10 illustrates various components that may be utilized in a base core network (CN) 906. The core network (CN) 906 may include components that are similar to the components discussed above in relation to the machine type communication (MTC) device 804, including a processor 903, memory 905 that provides instructions 907a and data 909a to the processor 903, instructions 907b and data 909b that may reside in the processor 903, a housing that contains a transmitter 911 and a receiver 913 (which may be combined into a transceiver 915), an antenna 917 electrically coupled to the transceiver 915, a bus system 919, a digital signal processor (DSP) 921 for use in processing signals, a communications interface 923, and so forth.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for controlling network resource usage of a machine type communication (MTC) device, comprising:
receiving a request for network resources from an MTC application;
sending a notification to a core network (CN) of a status of the MTC application;
receiving a set of commands from the CN; and
performing the commands as instructed by the CN.

2. The method of claim 1, further comprising:
obtaining a set of device rules governing the network resource usage of the MTC device; and
applying the set of device rules each time an MTC application requests network resources.

3. The method of claim 2, wherein the set of device rules governing the network resource usage of the MTC device are hard coded on the MTC device at the time of manufacture.

4. The method of claim 2, wherein the set of device rules governing the network resource usage of the MTC device are sent by the CN to the MTC device.

5. The method of claim 2, wherein the set of device rules governing the network resource usage of the MTC device are a combination of device rules hard coded on the MTC device at the time of manufacture and device rules sent by the CN to the MTC device.

6. The method of claim 2, wherein applying the set of device rules comprises comparing a network resource usage metric with a network resource usage threshold.

7. The method of claim 6, further comprising denying the request for network resources if the network resource usage metric is greater than the network resource usage threshold.

8. The method of claim 7, wherein the notification sent to the CN indicates that the MTC application has exceeded the network resource usage threshold.

9. The method of claim 6, further comprising:
granting the request for network resources if the network resource usage metric is less than the network resource usage threshold; and
providing network resources to the MTC application.

10. The method of claim 9, wherein the notification sent to the CN indicates that the MTC application is near to exceeding the network resource usage threshold.

11. The method of claim 6, further comprising updating the network resource usage metric.

12. The method of claim 1, wherein the set of commands instructs the MTC device to stop providing the MTC application access to network resources.

13. The method of claim 1, wherein the set of commands instructs the MTC device to start providing the MTC application access to network resources.

14. The method of claim 1, wherein the set of commands instructs the MTC device to resume providing the MTC application access to network resources.

15. The method of claim 1, wherein the set of commands instructs the MTC device to report MTC application resource requests over time.

16. The method of claim 1, wherein the method is performed by the MTC device.

17. The method of claim 1, wherein the method is performed by an access stratum (AS) on the MTC device.

18. The method of claim 1, wherein the set of commands received from the CN are received via a broadcast control channel (BCH) transport channel.

19. The method of claim 1, wherein the set of commands received from the CN are received via a downlink shared channel (DL-SCH) transport channel.

20. The method of claim 2, wherein the device rules take into account at least one of: a number of access requests made by the MTC application over a given period of time, a number of access attempts made by the MTC device over a given period of time, an amount of time and frequency resources used over a given period of time, and a current traffic load on a network.

21. An apparatus configured for controlling network resource usage of a machine type communication (MTC) device, the apparatus comprising:
a processor;
memory in electronic communication with the processor; and
instructions stored in the memory, the instructions being executable to:
receive a request for network resources from an MTC application;
send a notification to a core network (CN) of a status of the MTC application;
receive a set of commands from the CN; and
perform the commands as instructed by the CN.

22. The apparatus of claim 21, wherein the instructions are further executable to:
obtain a set of device rules governing the network resource usage of the MTC device; and
apply the set of device rules each time an MTC application requests network resources.

23. The apparatus of claim 22, wherein the set of device rules governing the network resource usage of the MTC device are hard coded on the MTC device at the time of manufacture.

24. The apparatus of claim 22, wherein the set of device rules governing the network resource usage of the MTC device are sent by the CN to the MTC device.

25. The apparatus of claim 22, wherein the set of device rules governing the network resource usage of the MTC device are a combination of devices rules hard coded on the MTC device at the time of manufacture and device rules sent by the CN to the MTC device.

26. The apparatus of claim 22, wherein the instructions executable to apply the set of device rules comprises instructions executable to compare a network resource usage metric with a network resource usage threshold.

27. The apparatus of claim 26, wherein the instructions are further executable to deny the request for network resources if the network resource usage metric is greater than the network resource usage threshold.

28. The apparatus of claim 27, wherein the notification sent to the CN indicates that the MTC application has exceeded the network resource usage threshold.

29. The apparatus of claim 26, wherein the instructions are further executable to:
grant the request for network resources if the network resource usage metric is less than the network resource usage threshold; and
provide network resources to the MTC application.

30. The apparatus of claim 29, wherein the notification sent to the CN indicates that the MTC application is near to exceeding the network resource usage threshold.

31. The apparatus of claim 26, wherein the instructions are further executable to update the network resource usage metric.

32. The apparatus of claim 21, wherein the set of commands instructs the MTC device to stop providing the MTC application access to network resources.

33. The apparatus of claim 21, wherein the set of commands instructs the MTC device to start providing the MTC application access to network resources.

34. The apparatus of claim 21, wherein the set of commands instructs the MTC device to resume providing the MTC application access to network resources.

35. The apparatus of claim 21, wherein the set of commands instructs the MTC device to report MTC application resource requests over time.

36. The apparatus of claim 21, wherein the apparatus is the MTC device.

37. The apparatus of claim 21, wherein the instructions are executable by an access stratum (AS) on the MTC device.

38. The apparatus of claim 21, wherein the set of commands received from the CN are received via a broadcast control channel (BCH) transport channel.

39. The apparatus of claim 21, wherein the set of commands received from the CN are received via a downlink shared channel (DL-SCH) transport channel.

40. The apparatus of claim 22, wherein the device rules take into account at least one of: a number of access requests made by the MTC application over a given period of time, a number of access attempts made by the MTC device over a given period of time, an amount of time and frequency resources used over a given period of time, and a current traffic load on a network.

41. A method for controlling network resource usage of a machine type communication (MTC) device by a core network (CN), the method comprising:
receiving a notification from the MTC device;
generating a set of commands in response to the notification; and
sending the set of commands to the MTC device.

42. The method of claim 41, wherein the notification indicates that an MTC application has exceeded a network resource usage threshold.

43. The method of claim 41, wherein the notification indicates that an MTC application is near to exceeding a network resource usage threshold.

44. The method of claim 41, wherein the set of commands instructs the MTC device to stop providing an MTC application access to network resources.

45. The method of claim 41, wherein the set of commands instructs the MTC device to start providing an MTC application access to network resources.

46. The method of claim 41, wherein the set of commands instructs the MTC device to resume providing the MTC application access to network resources.

47. The method of claim 41, wherein the set of commands instructs the MTC device to report MTC application resource requests over time.

48. An apparatus configured for controlling network resource usage of a machine type communication (MTC) device, the apparatus comprising:
a processor;
memory in electronic communication with the processor; and
instructions stored in the memory, the instructions being executable to:
receive a notification from the MTC device;
generate a set of commands in response to the notification; and
send the set of commands to the MTC device.

49. The apparatus of claim 48, wherein the notification indicates that an MTC application has exceeded a network resource usage threshold.

50. The apparatus of claim 48, wherein the notification indicates that an MTC application is near to exceeding a network resource usage threshold.

51. The apparatus of claim 48, wherein the set of commands instructs the MTC device to stop providing an MTC application access to network resources.

52. The apparatus of claim 48, wherein the set of commands instructs the MTC device to start providing an MTC application access to network resources.

53. The apparatus of claim 48, wherein the set of commands instructs the MTC device to resume providing the MTC application access to network resources.

54. The apparatus of claim 48, wherein the set of commands instructs the MTC device to report MTC application resource requests over time.
